(19) United States
(12) Patent Application Publication
(10) Pub. No.: US 2006/0262706 A1
(43) Pub. Date: Nov. 23, 2006

(54) Optical storage medium

(75) Inventors: Chia-Che Wu, Hsinchu (TW); Jen-Wu Fang, Hsinchu (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Lite-On It Corp.

(21) Appl. No.: 11/432,459

(22) Filed: May 11, 2006

(30) Foreign Application Priority Data
May 18, 2005 (TW) 094116144

(51) Int. Cl. G11B 7/135

(52) U.S. Cl. 369/112.01

(57) ABSTRACT

A Super-RENS readable optical storage medium is used with an optical reading apparatus having an optical pickup head. The readable optical storage medium includes a substrate, a first track and a second track. The first track is formed on a surface of the substrate and has thereon a plurality of first recording marks. The first track is made of a phase changeable material with a first phase type and the first recording marks is made of the phase changeable material with a second phase type. The first phase type is distinguished from the second phase type in reflective coefficient. The second track is formed on the surface of the substrate and next to the first track. The second track is made of the phase changeable material with a third phase type distinguished from the first phase type in reflective coefficient.

### FIELD OF THE INVENTION

The present invention relates to an optical storage medium, and more particularly to a super-resolution near-field structure (Super-RENS) readable optical storage medium.

### BACKGROUND OF THE INVENTION

Because of continuous development of new science and technology nowadays, optical storage media also have been improved unceasingly. For example, the invention of phase change type optical disc is a masterpiece of optical storage industry. When writing data onto a phase change type optical disc, a laser beam emitted from a pick-up head module forms a tiny spot which can convert the recording layer of the phase-change type optical disc between the highly reflective crystalline type and the less reflective amorphous type. For instance, if the higher reflective crystalline type represents data “0” and the lower reflective amorphous type represents data “1”, an optical drive can record data onto an phase-change type optical disc by modulating the power and pulse duration of the laser equipped into the pick-up head module. Generally speaking, a laser beam with a high power and a short duration can make the recording layer change from crystalline type into amorphous type. Oppositely, a laser beam with a lower power and longer duration can make the recording layer change from amorphous type into crystalline type. By this way, a user can store any desired data onto a phase-change type optical disc. As known, storage capacity is a critical index of the optical storage medium. The storage capacity of the optical storage media is primarily determined by the spot size of the laser beam focused on the optical storage media. Furthermore, the spot size of the laser beam focused on the optical disc is constrained by a so-called diffraction-limited effect of the laser beam optical system of the pick-up head module. Traditionally, if a designer wants to reduce the spot size of the laser beam focused on the optical disc under the constrain of diffraction-limited effect, he could use a laser with shorter wave-length and an objective lens with higher numeric aperture (NA) in the pick-up head module. However, it has been become more and more difficult to increase the capacity of optical disc by this way.

In order to break the restriction of diffraction limited effect, a super-resolution near-field structure (Super-RENS) technology was developed for increasing storage capacity of the optical disc in recent years. In reality, it is not hard to record or write a mark beyond the diffraction limited effect, but the ultra-tiny mark which is smaller than the smallest spot size calculated by diffraction limited effect is very difficult to be read-out from current commercial optical drives. According to the principle of near-field optics, a Super-RENS drive can read the recorded mark which is smaller than the minimum spot size calculated by diffraction limited effect on a Super-RENS optical disc. Therefore, a remarkable increase in storage capacity is possible to carry out.

Referring to FIG. 1, a schematic view of a conventional Super-RENS readable optical disc is illustrated. In the Super-RENS readable optical disc, a recording layer 11 including alternate groove 12 and land 13 is formed on a substrate 10. The adjacent tracks of the recording layer 11 are discretely arranged at a regular interval, i.e. the track pitch 14. Typically, the recording layer 11 is made of a phase changeable material with a crystalline type or an amorphous type, and the recorded marks are located on the groove 12 of the recording layer 11. For reading or recording data from/into the optical disc, the laser beam emitted by the optical pickup head 15 is reflected by the optical disc and then transmitted to a light sensor to realize information from the disc. Since no recorded marks are situated on the land 13, the optical path difference between the laser beams projecting onto adjacent groove 12 and land 13 is used for performing the conventionally track-crossing control of the optical pickup head 15. Therefore, the track pitch 14 is readily suffered from the diffraction-limited effect. If the track pitch is too small, the track-crossing signal usually fails to be accurately identified. Under this circumstance, since the data are not normally read or written, the purpose of increasing the storage capacity of the Super-RENS readable optical disc is restricted.

Although the recorded marks on the Super-RENS optical disc are reduced and maintained below the diffraction-limited size, the track pitch of the optical disc is not cooperatively shrunk such that the storage capacity of the optical disc is not further increased.

### SUMMARY OF THE INVENTION

The present invention provides a super-resolution near-field structure (Super-RENS) readable optical storage medium having increased storage capacity.

In accordance with a first aspect of the present invention, the super-resolution near-field structure (Super-RENS) readable optical storage medium is used with an optical reading apparatus having an optical pickup head. The optical storage medium comprises a substrate, a first track and a second track. The first track is formed on a surface of the substrate and has thereon a plurality of first recording marks. The first track is made of a first phase changeable material with a first phase type and the first recording marks is made of the first phase changeable material with a second phase type. The first phase type is distinguished from the second phase type in reflective coefficient such that the optical pickup head is permissible to read the first recording marks according to the Super-RENS reading mechanism. The second track is formed on the surface of the substrate and next to the first track. The second track is made of a second phase changeable material with a third phase type distinguished from the first phase type in reflective coefficient such that the reflective coefficient difference between the first track and the second track allows the optical pickup head to perform the track-crossing operation according to the Super-RENS reading mechanism. The first phase-changeable material may be substantially the same as the second phase-changeable material.

In an embodiment, the laser beam emitted by the optical pickup head is projected onto the first track and the second track so as to successively perform a track-seeking operation, the track-crossing operation and the reading operation.

In an embodiment, the phase changeable material includes Ge₂Sb₂Te₅, In-Ge-Sb-Te, In-Ag-Ge-Sb-Te, Te-TeO₂, Sb-Se-Te, Ga-Se-Te, Ga-Se-Te-Ge, or In-Se. In a case that the first phase type is a crystal type, the second and the third phase types are amorphous types. In another case that the first phase type is an amorphous type, the second and third types are crystal types.

The first track and the second track are a groove and a land, respectively, and the groove is closer to the optical pickup head than the land. In an embodiment, the groove and the land are made of crystal type and amorphous type, respectively. In another embodiment, the groove and the land are made of amorphous type and crystal type, respectively.

The second track has thereon a plurality of second recording marks, which are made of a fourth phase type, wherein the fourth phase type is distinguished from the third phase type in reflective coefficient. In an embodiment, the third phase type is a crystal type, and the fourth phase type is an amorphous type. In another embodiment, the third phase type is an amorphous type, and the fourth phase type is a crystal type.

In accordance with a second aspect of the present invention, the super-resolution near-field structure (Super-RENS) readable optical storage medium is used with an optical reading apparatus having an optical pickup head. The optical storage medium comprises a substrate, a recording layer and a plurality of first recording marks. The recording layer is formed on a surface of the substrate and includes a first track and a second track next to each other. The first track and the second track are distinguishable in reflective coefficient such that the reflective coefficient difference between the first track and the second track allows the optical pickup head to perform the track-crossing operation according to the Super-RENS reading mechanism. The first recording marks are formed on the first track. The first track and the first recording marks are distinguishable in reflective coefficient such that the optical pickup head is permissible to read the first recording marks according to the Super-RENS reading mechanism.

In an embodiment, a plurality of second recording marks formed on the second track, wherein the second track and the second recording marks are distinguishable in reflective coefficient such that the optical pickup head is permissible to read the second recording marks according to the Super-RENS reading mechanism.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic view illustrating a conventional Super-RENS readable optical disc;

FIGS. 2(a) and 2(b) are a schematic views illustrating two examples of a Super-RENS readable optical disc according to a first preferred embodiment of the present invention;

FIG. 3 is a schematic views illustrating two examples of a Super-RENS readable optical disc according to a second preferred embodiment of the present invention;

FIG. 4 is a schematic views illustrating two examples of a Super-RENS readable optical disc according to a third preferred embodiment of the present invention;

FIG. 5 is a schematic views illustrating two examples of a Super-RENS readable optical disc according to a fourth preferred embodiment of the present invention;

FIG. 6 is a schematic views illustrating two examples of a Super-RENS readable optical disc according to a fifth preferred embodiment of the present invention; and

FIG. 7 is a schematic views illustrating two examples of a Super-RENS readable optical disc according to a sixth preferred embodiment of the present invention.

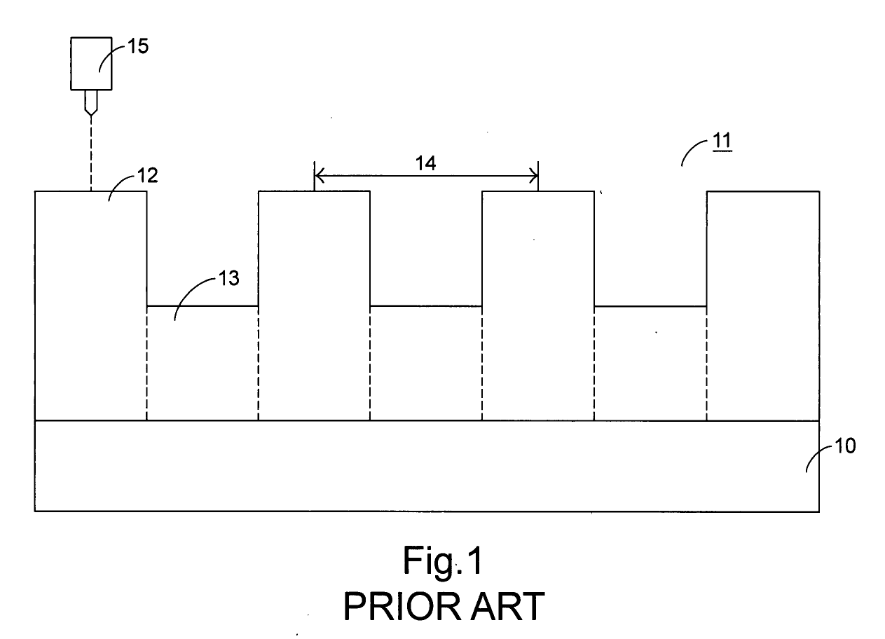

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

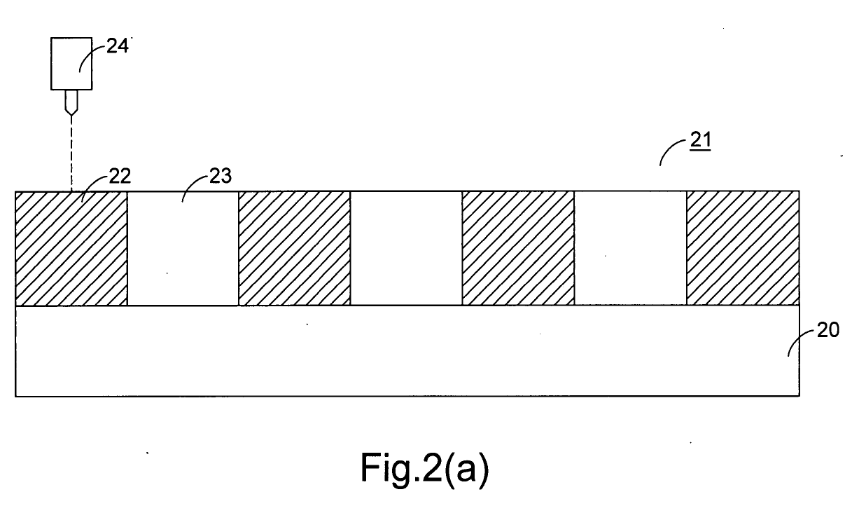

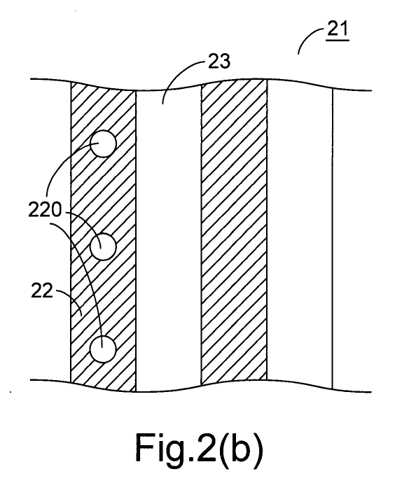

Referring to FIG. 2(a), a Super-RENS readable optical disc according to a first preferred embodiment of the present invention is illustrated. Generally, a typical Super-RENS readable optical disc includes a non-linear optical control layer, a recording layer and several protective layers formed on a substrate. Since the main feature of the present invention lies in the recording layer, the description involving the non-linear optical control layer and the protective layers will be omitted for a purpose of clarity. In the Super-RENS readable optical disc of FIG. 2(a), a recording layer 21 including alternate first track 22 and second track 23 is formed on a substrate 20. The first track 22 and the second track 23 have different reflective coefficients, and the first track and second track can be made of different phase-changeable materials as long as their reflective coefficients are different. Further more, the first track 22 and the second track 23 can also be made of substantially the same phase-changeable material. In this case, the first track 22 and the second track 23 of the recording layer 21 are made of a phase changeable material with a first phase type and the phase changeable material with a second phase type, respectively. The phase changeable material is produced by mixing germanium/antimony/tellurium or silver/indium/antimony/tellurium and then doping other elements via ion implantation. Exemplary the phase changeable material includes Ge₂Sb₂Te₅, In-Ge-Sb-Te, In-Ag-Ge-Sb-Te, Te-TeO₂, Sb-Se-Te, Ga-Se-Te, Ga-Se-Te-Ge, In-Se and the like. Each of above mentioned materials has two phase types changed between the crystalline phase and the amorphous phase when the laser beam emitted from the optical pickup head 24 is projected thereon. In the example of FIG. 2(a), the first and second phase types of the phase changeable material are crystal type and amorphous type, and the corresponding reflective coefficients of the first and second types are different. For reading data from the optical disc by using Super-RENS technology, the laser beam emitted by the optical pickup head 24 is reflected by the optical disc and then transmitted to a light sensor to realize information from the disc. Due to the reflective coefficient difference between the crystalline phase and the amorphous phase, track-seeking and track-crossing operations of the optical pickup head 24 are implemented.

Referring to FIG. 2(b), a schematic partial top view of the Super-RENS readable optical disc as shown in FIG. 2(a) is illustrated. The first track 22 and the second track 23 of the recording layer 21 are made of phase changeable materials with crystal type and amorphous type, respectively. Several recording marks 220, which are made of an amorphous type, are formed on the first track 22. During the process of reading data from the optical disc, the spot size of the laser beam emitted by the optical pickup head 24 is reduced below the diffraction-limited size. Due to the reflective coefficient difference between the first track 22 and the recording marks 220, the optical pickup head 24 can read the recording marks 220 according to the Super-RENS reading mechanism. Moreover, since the first track 22 and the second track 23 have different reflective coefficients, the reflective coefficient difference between the first track 22 and the second track 23 allows the optical pickup head 24 to effectively perform the track-seeking and track-crossing operations.

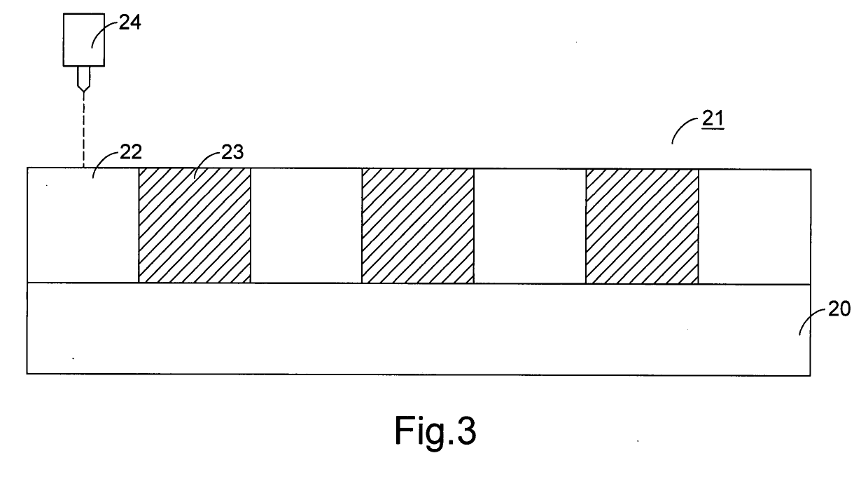

A second embodiment of a Super-RENS readable optical disc is illustrated in FIG. 3. The Super-RENS readable optical disc of this embodiment is substantially the same as that shown in FIG. 2, except that the first track 22 and the second track 23 of the recording layer 21 are amorphous type and crystal type, respectively. The first track and the second track need not be made of the same phase-changeable material. Likewise, due to the reflective coefficient difference between the first track 22 and the second track 23, the optical pickup head 24 may effectively perform the track-seeking and track-crossing operations.

In the above embodiments, the Super-RENS readable optical disc of the present invention is capable of breaking through the diffraction-limited effect of the laser beam. In addition, the track pitch of the optical disc is also shrunk to increase two-dimensional storage capacity of the optical disc.

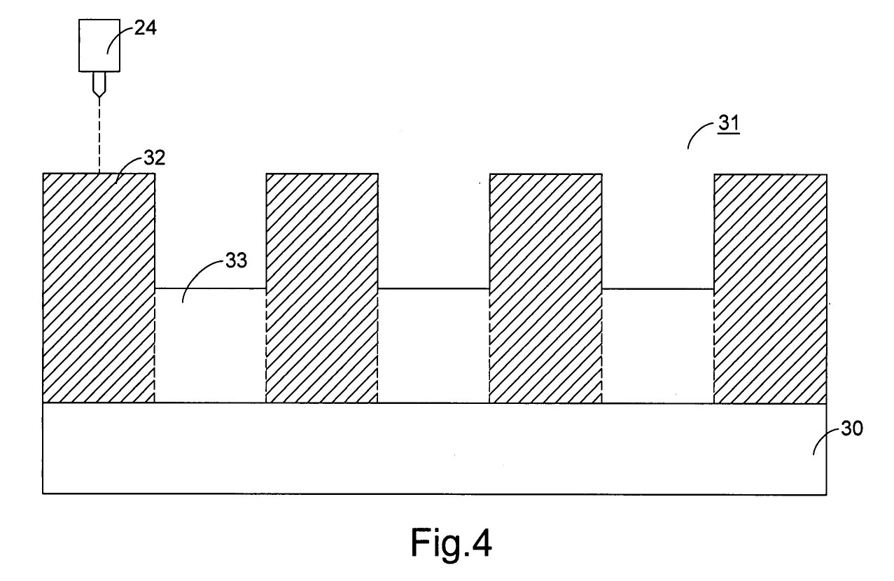

Referring to FIG. 4, a schematic view of a Super-RENS readable optical disc according to a third embodiment of the present invention is illustrated. In the Super-RENS readable optical disc of FIG. 4, a recording layer 31 including alternate groove 32 and land 33 is formed on a substrate 30. The groove 32 is closer to the optical pickup head 24 than the land 33. The groove 32 and the land 33 of the recording layer 31 are used as a first track and a second track, respectively. In this embodiment, the groove 32 is made of a phase changeable material with crystal type. Whereas, the land 33 is made of the phase changeable material with an amorphous type. Since the groove 32 and the land 33 have different reflective coefficient, the reflective coefficient difference between the groove 32 and the land 33 allows the optical pickup head 24 to effectively perform the track-seeking and track-crossing operations according to the Super-RENS reading mechanism.

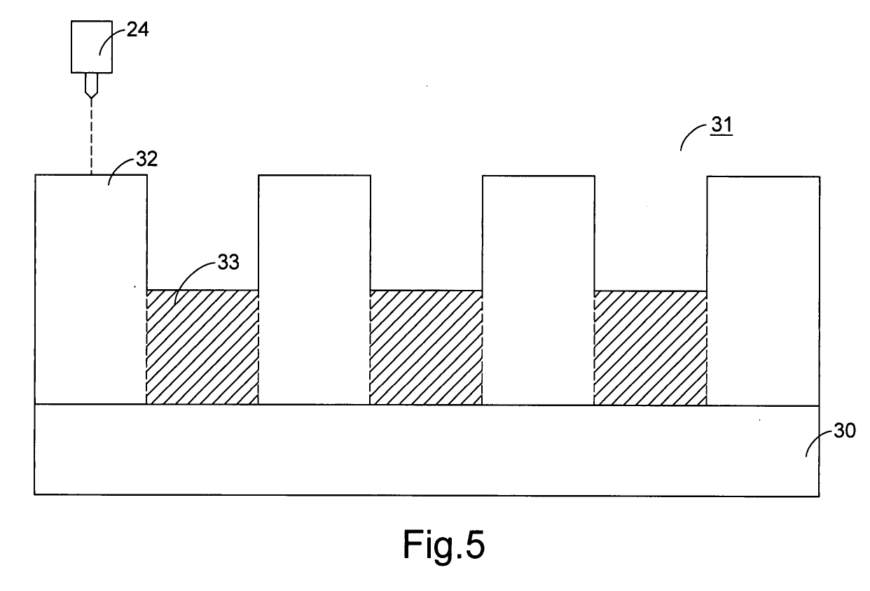

A fourth embodiment of a Super-RENS readable optical disc is illustrated in FIG. 5. The Super-RENS readable optical disc of this embodiment is substantially the same as that shown in FIG. 4, except that the groove 32 and the land 33 of the recording layer 31 are amorphous type and crystal type, respectively. Likewise, due to the reflective coefficient difference between the groove 32 and the land 33, the optical pickup head 24 may effectively perform the track-seeking and track-crossing operations.

In the above embodiments, the Super-RENS readable optical disc of the present invention is capable of avoiding the diffraction-limited effect of the laser beam. In addition, in a case that the track pitch of the optical disc is shrunk, the purpose of increasing the two-dimensional storage capacity of the optical disc is achieved.

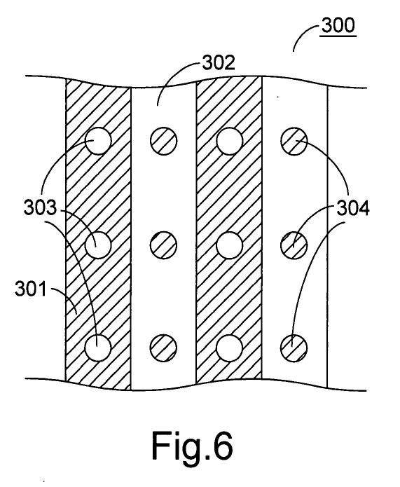

Referring to FIG. 6, a schematic partial top view of a Super-RENS readable optical disc according to a fifth embodiment of the present invention is illustrated. The first track 301 and the second track 302 of the recording layer 300 are made of different or substantially the same phase changeable materials with different reflective coefficient. Several first recording marks 303, which are made of an amorphous type, are formed on the first track 301. In addition, several second recording marks 304, which are made of a crystal type, are formed on the second track 302. In other words, the recording marks on the first track have different reflective coefficient from the marks on the second track. Due to the reflective coefficient difference between the first track 301 and the first recording marks 303, the optical pickup head can read the recording marks 303 according to the Super-RENS reading mechanism. Likewise, due to the reflective coefficient difference between the second track 302 and the second recording marks 304, the optical pickup head can read the recording marks 304 according to the Super-RENS reading mechanism. Moreover, since the first track 301 and the second track 302 have different reflective coefficient, the reflective coefficient difference between the first track 301 and the second track 302 allows the optical pickup head 24 to effectively perform the track-seeking and track-crossing operations.

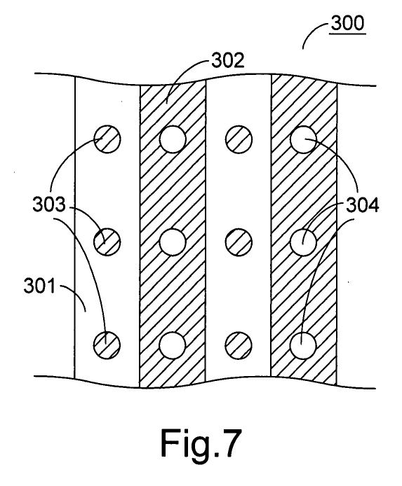

A sixth embodiment of a Super-RENS readable optical disc is illustrated in FIG. 7. The Super-RENS readable optical disc of this embodiment is substantially the same as that shown in FIG. 6, except that the second track 302 and the first recording marks 303 are made of crystal type and the first track 301 and the second recording marks 304 are made of amorphous type.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A super-resolution near-field structure (Super-RENS) readable optical storage medium for use with an optical reading apparatus having an optical pickup head, said optical storage medium comprising:
a substrate;
a first track formed on a surface of the substrate and having thereon a plurality of first recording marks, said first track being made of a first phase changeable material with a first phase type and said first recording marks being made of said first phase changeable material with a second phase type, wherein said first phase type is distinguished from said second phase type in reflective coefficient such that the optical pickup head is permissible to read said first recording marks according to the Super-RENS reading mechanism; and
a second track formed on the surface of the substrate and next to said first track, wherein said second track is made of a second phase changeable material with a third phase type distinguished from said first phase type in reflective coefficient such that the reflective coefficient difference between said first track and said second track allows said optical pickup head to perform the track-crossing operation according to the Super-RENS reading mechanism.

2. The optical storage medium according to claim 1 wherein the laser beam emitted by the optical pickup head is projected onto said first track and said second track so as to successively perform a track-seeking operation, the track-crossing operation and the reading operation.

3. The optical storage medium according to claim 1 wherein said phase changeable material includes Ge₂Sb₂Te₅, In-Ge-Sb-Te, In-Ag-Ge-Sb-Te, Te-TeO₂, Sb-Se-Te, Ga-Se-Te, Ga-Se-Te-Ge, or In-Se.

4. The optical storage medium according to claim 1 wherein said first phase-changeable material and said second phase-changeable material are substantially the same.

5. The optical storage medium according to claim 1 wherein said first phase type is a crystal type, and said second and the third phase types are amorphous types.

6. The optical storage medium according to claim 1 wherein said first phase type is an amorphous type, and said second and third types are crystal types.

7. The optical storage medium according to claim 1 wherein said first track and said second track are a groove and a land, respectively, and said groove is closer to the optical pickup head than said land.

8. The optical storage medium according to claim 7 wherein said groove and said land are made of crystal type and amorphous type, respectively.

9. The optical storage medium according to claim 7 wherein said groove and said land are made of amorphous type and crystal type, respectively.

10. The optical storage medium according to claim 1 wherein said second track has thereon a plurality of second recording marks, which are made of a fourth phase type, wherein said fourth phase type is distinguished from said third phase type in reflective coefficient.

11. The optical storage medium according to claim 10 wherein said third phase type is a crystal type, and said fourth phase type is an amorphous type.

12. The optical storage medium according to claim 10 wherein said third phase type is an amorphous type, and said fourth phase type is a crystal type.

13. A super-resolution near-field structure (Super-RENS) readable optical storage medium for use with an optical reading apparatus having an optical pickup head, said optical storage medium comprising:
a substrate;
a recording layer formed on a surface of the substrate and including a first track and a second track next to each other, wherein said first track and said second track are distinguishable in reflective coefficient such that the reflective coefficient difference between said first track and said second track allows said optical pickup head to perform the track-crossing operation according to the Super-RENS reading mechanism; and
a plurality of first recording marks formed on said first track, wherein said first track and said first recording marks are distinguishable in reflective coefficient such that the optical pickup head is permissible to read said first recording marks according to the Super-RENS reading mechanism.

14. The optical storage medium according to claim 13 wherein a plurality of second recording marks formed on said second track, wherein said second track and said second recording marks are distinguishable in reflective coefficient such that the optical pickup head is permissible to read said second recording marks according to the Super-RENS reading mechanism.

15. The optical storage medium according to claim 13 wherein the laser beam emitted by the optical pickup head is projected onto said first track and said second track so as to successively perform a track-seeking, the track-crossing operation and the reading operation.

16. The optical storage medium according to claim 13 wherein said first track and said second recording marks are made of crystal type, and said second track and said first recording marks are made of amorphous types.

17. The optical storage medium according to claim 13 wherein said first track and said second recording marks are made of amorphous type, and said second track and said first recording marks are made of crystal types.
